(19) United States
(12) Patent Application Publication
(10) Pub. No.: US 2006/0048114 A1
(43) Pub. Date: Mar. 2, 2006

(54) Method and apparatus for dynamic compilation of selective code blocks of computer programming code to different memory locations

(75) Inventor: William Jon Schmidt, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/932,944

(22) Filed: Sep. 2, 2004

(51) Int. Cl. G06F 9/45

(52) U.S. Cl. 717/148

(57) ABSTRACT

A dynamic compiler analyzes the frequency of execution of selective code paths within a program procedure, and selectively compiles code paths to different memory locations based on the observed frequency of execution. Preferably, code is dynamically compiled in two stages. In a first compilation stage, the compiler instruments selective code paths to count the number of times each path is taken. A second stage compilation is thereafter triggered when the procedure has been called some threshold number of times. In the second stage, the compiler selectively re-compiles the more frequently executed code paths to a primary location, and re-compiles the remaining code paths to an alternate location. Placing infrequently executed code in an alternate location reduces the size of the primary code area, improving execution efficiency.

### FIELD OF THE INVENTION

The present invention relates to digital data processing, and in particular to methods and apparatus for dynamic compilation of computer programming code.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises one or more central processing units (CPU) and supporting hardware necessary to store, retrieve and transfer information, such as communication buses and memory. It also includes hardware necessary to communicate with the outside world, such as input/output controllers or storage controllers, and devices attached thereto such as keyboards, monitors, tape drives, disk drives, communication lines coupled to a network, etc. The CPU or CPUs are the heart of the system. They execute the instructions which comprise a computer program and directs the operation of the other system components.

From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Sophisticated software at multiple levels directs a computer to perform massive numbers of these simple operations, enabling the computer to perform complex tasks. What is perceived by the user as a new or improved capability of a computer system is made possible by performing essentially the same set of very simple operations, but using software having enhanced function, along with faster hardware.

In the very early history of the digital computer, computer programs which instructed the computer to perform some task were written in a form directly executable by the computer's processor. Such programs were very difficult for a human to write, understand and maintain, even when performing relatively simple tasks. As the number and complexity of such programs grew, this method became clearly unworkable. As a result, alternate forms of creating and executing computer software were developed. In particular, a large and varied set of high-level languages was developed for supporting the creation of computer software.

High-level languages vary in their characteristics, but all such languages are intended to make it easier for a human to write a program to perform some task. Typically, high-level languages represent instructions, fixed values, variables, and other constructs in a manner readily understandable to the human programmer rather than the computer. Such programs are not directly executable by the computer's processor. In order to run on the computer, the programs must first be transformed from a human-readable form (source code) to something executable by the computer. In general, source code is universal and understandable by anyone trained to use the applicable language, while executable code is specific to a particular computer system environment (model of hardware, operating system, etc.), and can only execute on that computer system or one similarly configured.

In recent years, object-oriented programming concepts have been increasingly employed in high-level languages. The goal of using object-oriented programming is to create small, reusable sections of programming code known as “objects”, that can be quickly and easily combined and re-used as building blocks to create different programs. The modular and re-usable aspects of objects will typically speed development of new programs, thereby reducing the costs, particularly human resource costs, associated with the development cycle. In addition, by creating and re-using a comprehensive set of well-tested objects, a more stable, uniform and consistent approach to developing new computer programs can be achieved.

Various programming languages have been developed to support the object-oriented programming approach. In particular, the JAVA™ programming language developed by Sun Microsystems has become very popular in recent years.

The JAVA language promotes the re-use and portability of code from one computer system to another by the use of an intermediate code form and dynamic compilation. Human readable JAVA source code is translated to an intermediate code form, known as “byte code”. Byte code is a universal, partially compiled form, which can be ported to and executed on any computer system having a suitable JAVA interpreter. Dynamic compilation, also known as just-in-time (JIT) compilation, is used to compile byte code into directly executable code at the time the program is executed. The JIT compiler is therefore part of a JAVA interpreter which executes programs in JAVA byte code form.

JAVA byte codes can either be interpreted or compiled. Interpreting code means that each individual byte code is effectively treated as a self-contained procedure at the level of executable code, the byte code being translated by the interpreter to a set of executable instructions which execute the self-contained procedure. Because each byte code is self-contained, this translation can be performed as the code is executed. Compilation considers the program flow of multiple byte codes together, and is therefore able to make certain optimizations to the executable code, producing executable code which is more efficient. However, compilation is a complicated process which itself consumes considerable resource. The execution efficiencies produced by compilation are generally not justified unless the compiled code will be executed multiple times.

Compared to more conventional static compilation, in which a program is compiled once, and the compiled version is executed multiple times, the use of just-in-time (JIT) compilation involves certain trade-offs. The obvious disadvantage of JIT compilation is that code is re-compiled every time the program is executed. However, there are certain countervailing advantages. The code is more portable, since byte code programs can be executed on any system with a suitable JAVA interpreter. It is easier to maintain, particularly when importing objects which are subject to frequent changes from diverse source locations. Finally, because the JIT compiler performs compilation at run time, when certain variables are known, it is often able to achieve greater execution optimization than a static compiler, which must make worst-case assumptions about unknown variable values.

There are, however, certain additional disadvantages of dynamically compiled code vis-a-vis statically compiled code. It is possible to gather extensive execution performance statistics concerning statically compiled code (a process known as “profiling”), and to re-compile the code using these performance statistics as a guide for optimization. Such data can be used, e.g., to identify the most frequently executed code paths, and to perform certain optimizations with respect to these paths. Conventional dynamic compilers do not employ profiling optimizations due to the apparent burden of obtaining suitable performance data.

In order to reduce the burden of dynamic compilation, a typical JIT compiler does not simply compile all the code in a JAVA program when the program is invoked. A typical JAVA program contains re-usable objects which may have been originally written for different applications. While the code within these objects executes correctly for multiple diverse applications, not all of the code is used by each and every application. I.e., the objects may contain code which is not necessary for the application invoked for execution, and which will never be executed. In may also contain code which is rarely executed within the invoked application. It would make little sense to compile all this code. Accordingly, a conventional JIT compiler typically does not compile a JAVA code procedure (referred to as a “method”) until the method is actually called. Some JIT compilers take this selective compilation one step further, and delay compilation of a method until it has been called some minimum number of times. As a result, the JIT compiler generally is not required to compile all the code, and in many cases compiles only a small fraction of the code. Ideally, this small fraction contains the most frequently executed code.

Although JIT compilation of selective methods reduces the burden of compilation while maintaining compilation efficiencies with respect to certain frequently executed methods, the results of JIT compilation are not entirely satisfactory. In particular, many frequently executed methods written in object-oriented languages such as JAVA contain large blocks of rarely used code, or code which is not used for every application which includes or imports the method. JIT compilation of these methods results in an unduly large dynamic code cache in memory, reducing the execution efficiency of the compiled code. This is particularly true in the presence of method inlining. A need exists for a JIT compilation method and apparatus which would further improve the execution efficiency of JIT compiled code while still maintaining the more important advantages of dynamic compilation.

### SUMMARY OF THE INVENTION

A dynamic compiler analyzes the frequency of execution of selective code paths within a procedure (or method) of a program. If the procedure (or method) is selected for compilation, the compiler selectively compiles code paths to different memory locations based on the observed frequency of execution.

In the preferred embodiment, the dynamic compiler compiles code in two stages. Initially, a complete procedure (or method) is compiled based on some trigger, such as the procedure having been called one or more times. When compiling in the first stage, the compiler instruments selective code paths within the procedure to count the number oftimes each path is taken. A second stage compilation is thereafter triggered when the procedure has been called some different threshold number of times. In the second stage, the compiler selectively re-compiles the more frequently executed code paths to a contiguous range of allocated memory called the primary code cache, and re-compiles the remaining code paths to an alternate code cache location in memory. The second stage of compilation utilizes a higher degree of optimization than the first stage.

In the preferred embodiment, the compiler instruments only “gating branches”, i.e., code branches at which code flow diverges, and later converges. The compiler does not attempt to instrument every possible code flow path. Instrumenting only the gating branches reduces the number of instrumentation points and simplifies the dynamic analysis required for triggering a second stage of compilation. It would alternatively be possible to instrument other code paths, or to selectively compile code paths based on other indicia.

By selectively re-compiling and placing in the primary code cache only those code paths within a procedure exhibiting a high frequency of execution, the size of the primary code cache is substantially reduced. The reduced size generally reduces the length of jumps within the frequently executed code paths, improves the probability of a cache hit, and reduces the amount of paging required. All of these factors tend to improve the execution efficiency of the resultant compiled code.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for dynamically compiling selective blocks of code to different memory locations, according to the preferred embodiment of the present invention.

FIG. 2 is a conceptual illustration of the major software components of a computer system for dynamically compiling selective blocks of code to different memory locations, according to the preferred embodiment.

FIG. 3 is a conceptual illustration showing in greater detail certain temporary data maintained to support interpretation and dynamic compilation, according to the preferred embodiment.

FIG. 4 is a conceptual illustration showing a structure of a very simplified control flow graph, according to the preferred embodiment.

FIG. 5 is a high-level flow diagram showing the overall process of executing a JAVA bytecode program, according to the preferred embodiment.

FIG. 6 is a flow diagram showing in expanded form the first-stage dynamic compilation process, within the process of FIG. 5, according to the preferred embodiment.

FIG. 7 is a flow diagram showing in expanded form the second-stage dynamic compilation process, within the process of FIG. 5, according to the preferred embodiment.

### DETAILED DESCRIPTION OF THE PREFERRED EMBODIMENT

Overview of Environment

The present invention relates to the dynamic compilation of computer programming code. Dynamic compilation is particularly useful in object-oriented programming environments, of which the JAVA programming language is an outstanding example. The preferred embodiment of the present invention is described herein in the context of a JAVA programming environment. Accordingly, a brief overview is provided herein of object-oriented technology, and the JAVA programming language. However, it will be understood that the present invention is not necessarily limited to the JAVA programming environment, or to object-oriented programing environments in general.

Object-Oriented Technology v. Procedural Technology

Object-oriented programming is a method of implementation in which programs are organized as cooperative collections of objects, each of which represents an instance of some class, and whose classes are all members of a hierarchy of classes united via inheritance relationships. Object-oriented programming differs from standard procedural programming in that it uses objects, not algorithms, as the fundamental building blocks for creating computer programs. This difference stems from the fact that the design focus of object-oriented programming technology is wholly different than that of procedural programming technology.

The focus of procedural-based design is on the overall process that solves the problem; whereas, the focus of object-oriented design is on how the problem can be broken down into a set of autonomous entities that can work together to provide a solution. The autonomous entities of object-oriented technology are, of course, objects. Said another way, object-oriented technology is significantly different from procedural technology because problems are broken down into sets of cooperating objects instead of into hierarchies of nested computer programs or procedures.

Thus, a pure object-oriented program is made up of code entities called objects. Each object is an identifiable, encapsulated piece of code that provides one or more services when requested by a client. Conceptually, an object has two parts, an external object interface and internal object data. In particular, all data is encapsulated by the object interface such that other objects must communicate with that object through its object interface. The only way to retrieve, process or otherwise operate on the encapsulated data is through the external interface for the procedures defined on the object. This protects the internal data portion of the object from outside tampering. Additionally, because outside objects have no access to the internal implementation of an object, that internal implementation can change without affecting other aspects of the program. In the JAVA language and in certain other object-oriented languages, these procedures are called “methods”, and that terminology is used herein for clarity, without limiting the scope of the present invention.

In this way, the object system isolates the requester of services (client objects) from the providers of services (server objects) by a well defined encapsulating interface. Thus, in the classic object model, a client object sends request messages (e.g., method calls) to server objects to perform any necessary or desired function. The message identifies a particular server object and specifies what method is to be performed by the server object, and also supplies any required parameters. The server object receives and interprets the message, and can then determine what service to perform.

Because all operations on an object are expressed as methods called from one object to another, methods can be called by objects in other processes. Objects that reside in one process and that are capable of calling methods on an object in another process (such as a process on a remote computer system) are known as distributed objects.

Many distributed object systems allow interaction between objects in remote locations over a communications link. In a distributed object system a “client object” in one location calls methods on a “server object” in another location, which may be a remote location. The client object—server object interactions form the basis for the distributed object system.

Another central concept in object oriented programming is the class. A class is a template that defines a type of object. A class outlines the makeup of objects that belong to that class. By defining a class, objects can be created that belong to the class without having to rewrite the entire definition for each new object as it is created. This feature of object-oriented programming promotes the reusability of existing definitions and promotes efficient use of program code. Each class has corresponding configuration data that determines the features or attributes of the class. Changing the configuration data for a class changes the existing class to a new class.

There are many computer languages that currently support object-oriented programming techniques. For example, Smalltalk, Object Pascal, C++ and JAVA are all examples of programming languages that support object-oriented programming to one degree or another.

JAVA Programming Language

The JAVA programming language is a modern object-oriented programming language designed by Sun Microsystems that has grown in popularity in recent years. The JAVA language offers many features and advantages that makes it a desirable programming language to use. It is completely platform independent. A JAVA program can be written once and can then run on any type of platform that contains a JAVA Virtual Machine (JVM), i.e., contains a defined software run-time environment which will cause JAVA code to be executed, such as an interpreter and/or compiler and additional run-time support including garbage collection, exception management, and so forth. The JVM model is supported by most computer vendors, thereby allowing a software vendor to have access to hardware and software systems produced by many different companies. The JAVA language is an object-oriented language, meaning that software written in the JAVA language can take advantage of the benefits of object-oriented programming techniques. As in other object-oriented systems, operations in the JAVA language are performed by one object calling a method on another object.

As can be appreciated, source code of any language which has a rigorous and consistent definition is platform independent in the sense that it can be taken from one machine to another, and interpreted or compiled on the second machine assuming that the second machine has an appropriate interpreter or compiler which complies with the language definition. The JAVA language environment further includes a defined intermediate language form, referred to as JAVA bytecode form, which is also platform independent. A JAVA front-end compiler parses JAVA source to render the source in JAVA bytecode form. The bytecode form expresses commands as numeric codes having a predetermined placement of bit fields. The bytecode form is executed by a JVM specific to the executing computer system. The JVM, which includes a compiler or interpreter, receives bytecode form as input and generates machine-specific executable code. The bytecode form can be executed far more efficiently by an interpreter than can ordinary source code, since it is not necessary to parse the code, remove unnecessary characters, convert strings to commands, etc.

While the JAVA bytecode form is platform independent and achieves substantial performance improvement in interpretive mode over ordinary source code, it still lacks the performance of typical compiled code (i.e., directly executable code, or “object code”). As more and complex applications have been written in the JAVA language, it is only natural that programmers have asked for compilation tools which will render JAVA source or JAVA bytecode programs into compiled, executable code. However, here a trade-off must be made. Directly executable compiled code (object code) is always machine dependent, since it depends on the machine executable instruction set, the number of available hardware registers, and many other machine-specific factors. When JAVA bytecode programs are compiled into directly executable object code, platform independence is inevitably lost.

Just as in most programming languages, it is possible to compile a JAVA program to executable code once, in advance of execution, and to re-use (re-execute) the compiled version many times. This form of compilation is referred to herein as static compilation. However, in order to maximize platform independence, and to avoid the need for re-compiling where there are frequent changes to objects used in a JAVA program, JAVA programs (in bytecode form) are often executed in interpreted mode. Running a program in interpreted mode is naturally significantly slower than running compiled code, but the slower execution speed is often justified by the greater platform independence and maintainability. In order to mitigate the loss of performance inherent in interpreted mode execution, a JAVA program may alternatively be dynamically compiled at execution time, referred to as Just-in-Time (JIT) compilation. Typically, a JAVA JIT compiler does not compile an entire program at once, but only compiles methods which are actually executed. A JAVA JIT compiler may compile each method of a program when it is first called, or it may work in conjunction with an interpreter by delaying compilation of a method until the method has been called some minimum number of times.

Detailed Description

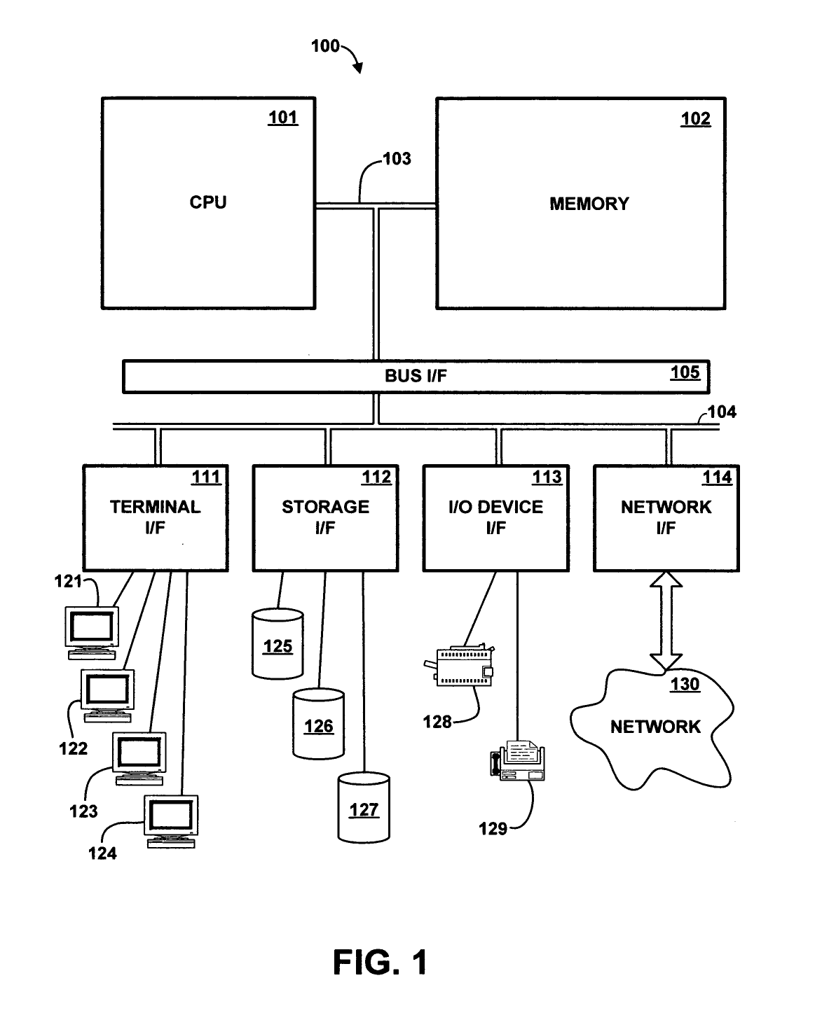

Referring to the Drawing, wherein like numbers denote like parts throughout the several views, FIG. 1 is a high-level representation of the major hardware components of a computer system 100 which dynamically compiles selective blocks of computer programming code to different memory locations, according to the preferred embodiment of the present invention. CPU 101 is a general-purpose programmable processor which executes instructions and processes data from main memory 102. Main memory 102 is preferably a random access memory using any of various memory technologies, in which data is loaded from storage or otherwise for processing by CPU 101.

Memory bus 103 provides a data communication path for transferring data among CPU 101, main memory 102 and I/O bus interface unit 105. I/O bus interface 105 is further coupled to system I/O bus 104 for transferring data to and from various I/O units. I/O bus interface 105 communicates with multiple I/O interface units 111-114, which may also be known as I/O processors (IOPs) or I/O adapters (IOAs), through system I/O bus 104. System I/O bus may be, e.g., an industry standard PCI bus, or any other appropriate bus technology. The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to an external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although memory bus 103 is shown in FIG. 1 as a relatively simple, single bus structure providing a direct communication path among CPU 101, main memory 102 and I/O bus interface 105, in fact memory bus 103 may comprise multiple different buses or communication paths, which may be arranged in any of various forms, such as point-to-point links in hierarchical, star or web configurations, multiple hierarchical buses, parallel and redundant paths, etc. Furthermore, while I/O bus interface 105 and I/O bus 104 are shown as single respective units, system 100 may in fact contain multiple I/O bus interface units 105 and/or multiple I/O buses 104. While multiple I/O interface units are shown which separate a system I/O bus 104 from various communications paths running to the various I/O devices, it would alternatively be possible to connect some or all of the I/O devices directly to one or more system I/O buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM AS/400™ or i/Series™ architecture, it being understood that the present invention could be implemented on other computer systems.

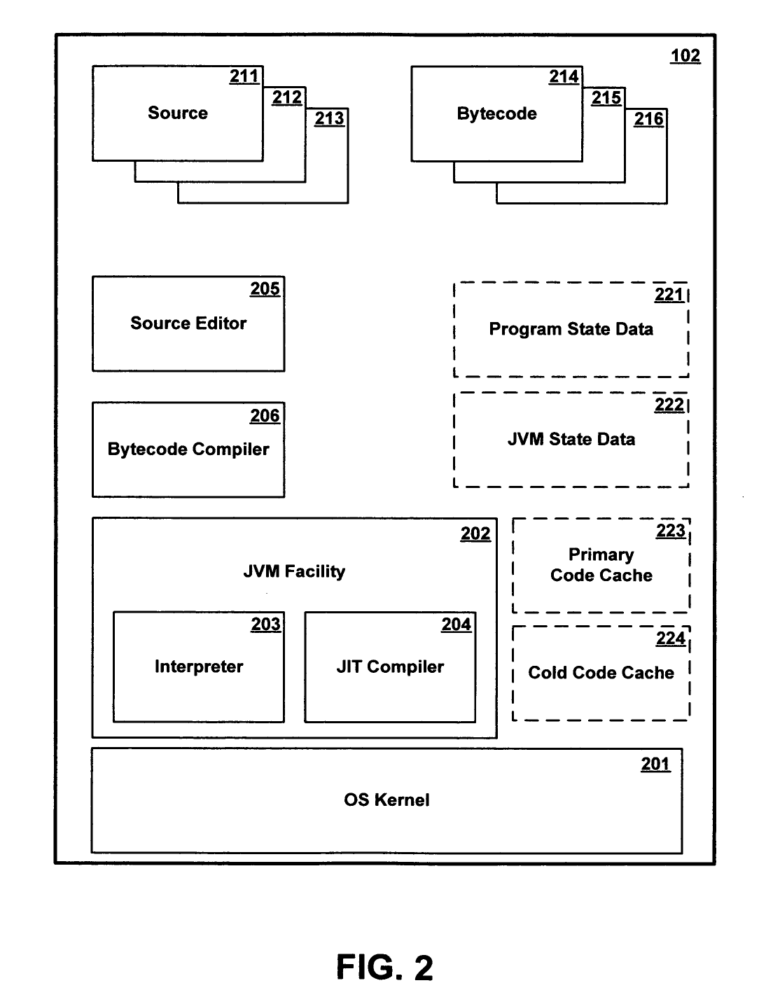

FIG. 2 is a conceptual illustration of the major software components of system 100 in memory 102. Operating system kernel 201 provides various low-level software functions, such as device interfaces, management of memory pages, management and dispatching of multiple tasks, and so forth, as is well-known in the art. JAVA Virtual Machine (JVM) facility 202 is a software facility supporting the execution of JAVA compliant programming code. I.e., JVM facility 202 is a set of executable instructions, state variables, and so forth, generally above the level of OS kernel 201 and below the level of most application programming code, which allows computer system 100 to properly execute any program in JAVA bytecode form, and thus function as a JAVA Virtual Machine. JVM facility 202 includes specifically JAVA interpreter 203 and JAVA Just-in-Time (JIT) compiler 204, as more fully described herein. Although JVM facility 202 is shown separate from OS Kernel 201 in the representation of FIG. 2, it will be appreciated that a JVM facility could be integrated with the operating system.

Source editor 205 is an executable computer program which supports the creation and editing of JAVA source code for other computer programs, using any of various known techniques. Source editor 205 may be a general-purpose text editor which is non-specific to a programming language, or may a special-purpose source editor particular to the JAVA language, having built-in syntax checking or other features. Source files 211-213 represent files containing JAVA source code, which are created and edited using editor 205.

Front-end (bytecode) compiler 206 is an executable program which converts JAVA source files 211-213 to an intermediate representation, specifically a JAVA bytecode representation. Bytecode files 214-216 represent files containing code in JAVA bytecode form. A bytecode file 214-216 generally represents user application code, which might be a stand-alone program, or might be some set of objects and methods which are included in other programs.

When a program in JAVA bytecode form is invoked for execution, JVM facility 202 “executes” the program by interpretation and/or JIT compilation, as described more fully herein. The word “executes” is in quotes because, as explained above, the bytecode is not directly machine executable, and therefore requires some form of translation to executable in order to execute, a function which is performed by the JVM facility. However, from the user's perspective, a program in JAVA bytecode form appears to execute on a machine having a JVM facility.

To support execution, JVM facility 202 creates temporary data objects in memory, as indicated by the dashed lines in FIG. 2. In particular, JVM facility creates program state data 221, JVM state data 222, primary code cache 223 and cold code cache 224. Program state data 221 includes data structures such as stack, heap and so forth, which maintain program state and are manipulated by the program during execution. JVM state data 222 is data used by JVM facility 202 to govern the operation of the JVM facility, including interpreter 203 and JIT compiler 204.

Code caches 223,224 hold compiled executable code generated by JIT compiler 204. In accordance with the preferred embodiment of the present invention, JIT compiler generates code to multiple (preferably two) separate memory locations. The most frequently executed blocks of code are placed in primary code cache 223, which the infrequently executed code is placed in cold code cache 224. Code caches 223, 224 are simply allocated portions of memory, and are not to be confused with hardware caches for temporarily storing memory data in a physical location closer to a processor. Preferably, primary code cache 223 occupies a contiguous range of memory addresses. Cold code cache 224 may be located adjacent or contiguous with primary code cache 223 (i.e., the first address of the cold code cache might be located immediately following the last address of the primary code cache), but this is not necessary.

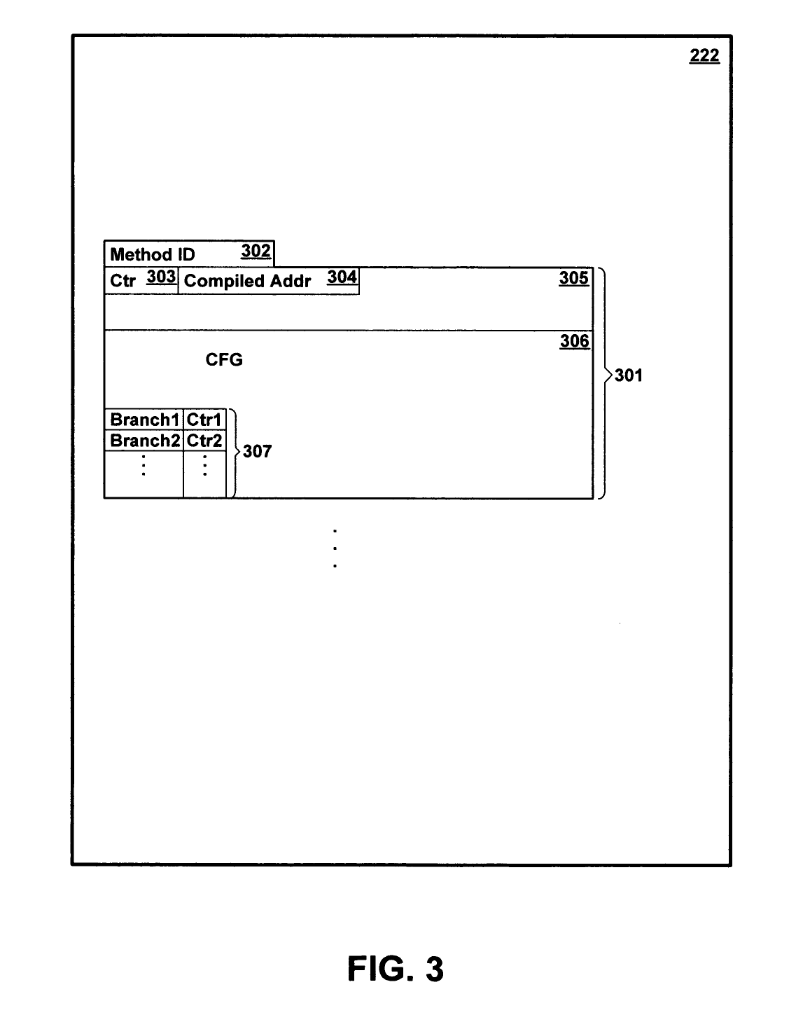

FIG. 3 represents in greater detail some of the data held in JVM state data 222. In addition to various other data, JVM state data 222 includes multiple method data sets 301, each method data set corresponding to a method invoked during execution. Each method data set 301 comprises a method identifier 302, a method counter 303, a compiled code address 304, and additional data concerning the method 305. Method identifier 302 uniquely identifies a method, and could be a pointer to a bytecode address, a line number of a bytecode, or any of various mechanisms for identifying a method. Method counter 303 records the number of times the method has been invoked during execution, and is used to trigger compilation of the method, as explained more fully herein. Compiled code address 304 records the address of the compiled code embodying the method, if such compiled code exists. If the method has been compiled, the method data set further includes a control flow graph (CFG) mapping 306 from the compilation, and a set of gating branch path counters 307 corresponding to gating branches within the method. Each gating branch path counter 307 records the number of times a corresponding gating branch path is taken during execution, as explained more fully herein.

Various software entities are represented in FIGS. 2 and 3 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIGS. 2 and 3, it will be understood that the actual number of such entities may vary, and in particular, that in a complex computer system environment, the number and complexity of such entities is typically much larger. Additionally, although software components 202-206 and 211-216 and 221-224 are depicted in FIG. 2 on a single computer system 100 for completeness of the representation, it is not necessarily true that all programs, functions and data will be present on a single computer system or will be performed on a single computer system. For example, source code might be developed and compiled to JAVA bytecode form on a separate computer system, and imported to system 100 in bytecode form for execution; in this case, system 100 might not contain any source code files 211-213, source code editor 205, or bytecode compiler 206.

While the software components of FIGS. 2 and 3 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. Furthermore, it will be understood that the conceptual representation of FIGS. 2 and 3 is not meant to imply any particular memory organizational model, and that system 100 might employ a single address space virtual memory, or might employ multiple virtual address spaces which overlap.

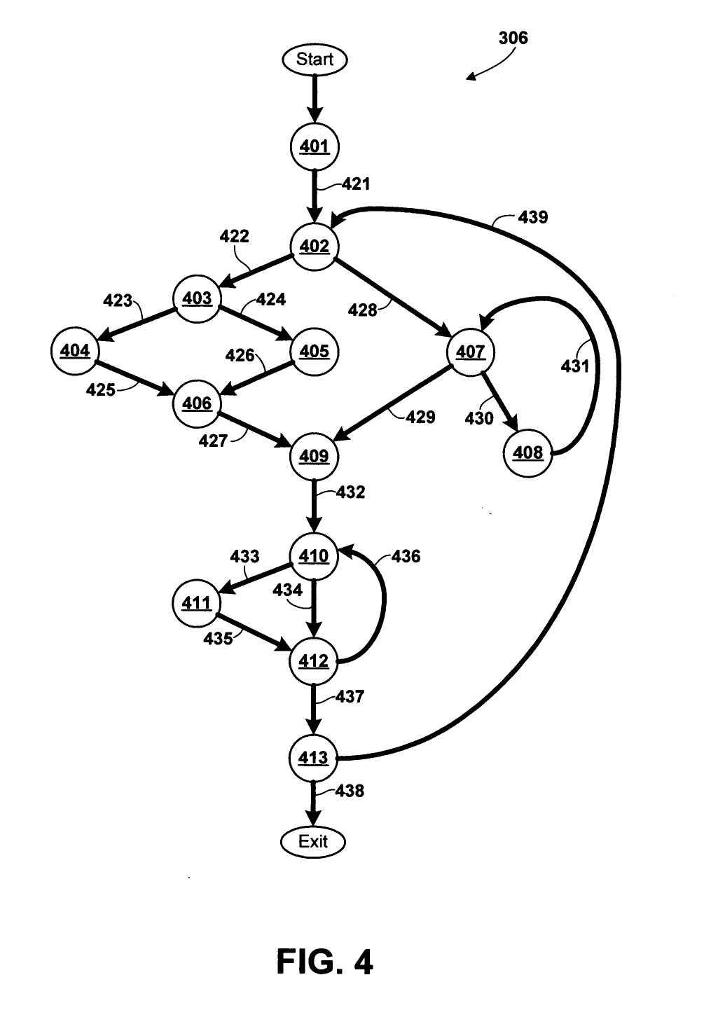

In accordance with the preferred embodiment, a JIT compiler compiles frequently executed code blocks to a primary code cache in memory, and infrequently executed code blocks to a cold code cache in memory, at a different memory location from the primary code cache. In order to effectively perform this function, the JIT compiler must make rational distinctions between frequently and infrequently executed code blocks. In the preferred embodiment, this is accomplished by instrumenting (i.e., placing counter incrementing instructions in) certain branches in the code, which are herein referred to as “gating branches”. Because this concept is used in the preferred embodiment to identify the infrequently executed code which will be placed in the cold code cache, it is important to understand what is meant by a “gating branch”. As used herein, a “gating branch” is a branch (divergence) in a code flow path, wherein the divergent paths ultimately converge at the same code block, without revisiting the gating branch. I.e., any time either of the divergent paths is taken during execution, the program must eventually execute the code at the point of convergence, without re-executing the branch. Thus, a loop is not a gating branch. There may, however, be arbitrary complexity in the paths of a gating branch, including other gating branches or loops. The concept of a gating branch is illustrated in the simplified control flow graph of FIG. 4.

FIG. 4 is a conceptual illustration showing a structure of a very simplified control flow graph 306, according to the preferred embodiment. It should be understood that FIG. 4 is a conceptual illustration, and that graph 306 is actually binary data, which may be structured according to any appropriate form, and further that an actual control flow graph is usually far more complex, having a much larger number of nodes and arcs. As shown in FIG. 4, a control flow graph contains a plurality of nodes 401-413 and directed arcs 421-439 connecting the nodes, each node representing a block of code having only a single straight path of execution (referred to as a “basic block”), and each arc representing a possible path (such as a branch) from one node to another.

It will be observed that some nodes in the graph of FIG. 4 have only a single arc leaving the nodes, and of course none of these are gating branches. Some nodes have two arcs leaving the nodes. For example, node 402 has outgoing arcs 422 and 428; node 407 has outgoing arcs 429 and 430. Node 402 is a gating branch, because the paths eventually converge at node 409. Thus, regardless of which path 422 or 428 is taken, eventually the program will execute node 409 without re-executing node 402. However, node 407 is not a gating branch, since there is no point of convergence (except through node 407 again). Gating branches can be nested, a phenomenon referred to as “control dependence”. I.e., a gating branch may lie entirely within one of the branch paths from a second gating branch, so that the first gating branch is only executed if that branch path is taken. In this case, the first gating branch is said to be control dependent on the second gating branch. Node 403 is control dependent on the gating branch at node 402. Of the nodes in the control flow graph of FIG. 4, only nodes 402, 403 and 410 are gating branches, because they converge at nodes 409, 406 and 412, respectively.

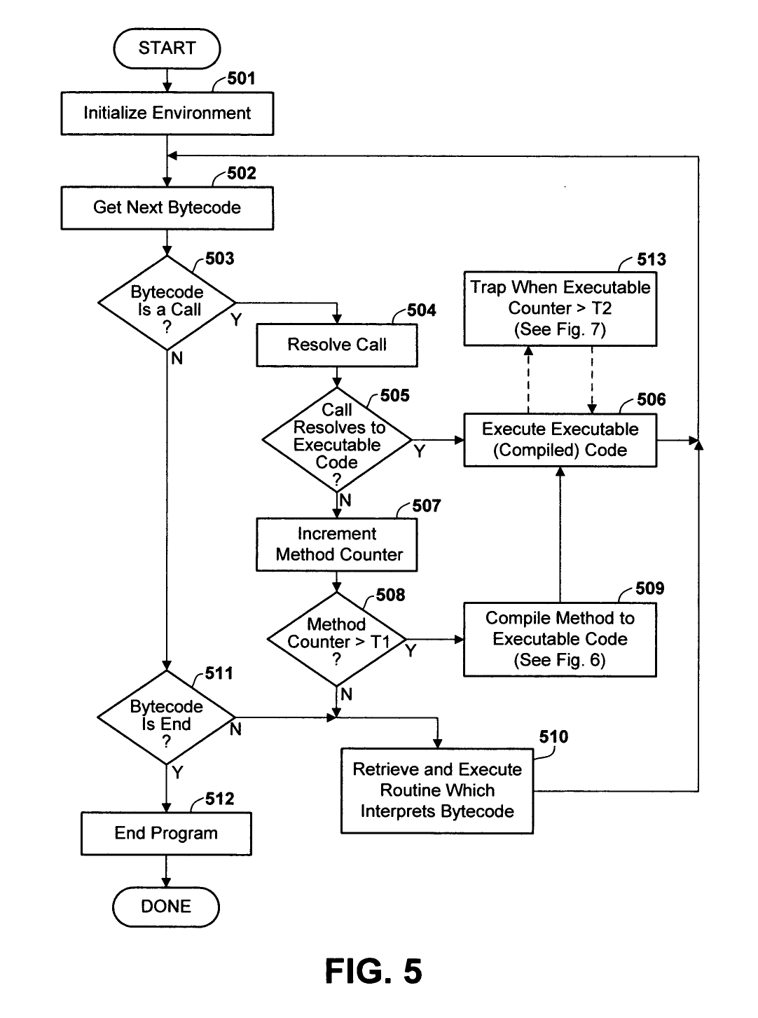

FIG. 5 is a high-level flow diagram showing the overall process of executing a JAVA bytecode program using JVM facility 202, according to the preferred embodiment. Referring to FIG. 5, when a JAVA bytecode program is invoked for execution, the JVM facility first initializes the environment (step 501). The JAVA interpreter 203 then commences execution of the program in interpretive mode. Execution in interpretive mode generally means successively retrieving individual instructions (bytecodes), and calling some routine to execute the retrieved bytecode, as represented by the main loop beginning at step 502. However, in this case certain special steps are taken in the case of a method call, as more fully explained.

As shown in FIG. 5, the interpreter retrieves the next bytecode for execution from the JAVA bytecode program being executed (step 502). If the bytecode is a method call, the ‘Y’ branch is taken from step 503. The interpreter then resolves the call, i.e. determines which method to call at run-time by examining the class of the object on whose behalf the method is invoked (step 504). If the method call resolves to a call to executable code (i.e., resolves to a method which was previously compiled by the JIT compiler), the ‘Y’ branch is taken from step 505, and the previously compiled executable code is executed by accessing the method's entry point in the primary code cache 223 (step 506). In this case, the entry point of a method will always be in the primary code cache, although some of the code contained in the method may be in the cold code cache 224. When the executable code in the code cache(s) is finished executing, the interpreter returns to step 502 to retrieve the next bytecode in the program.

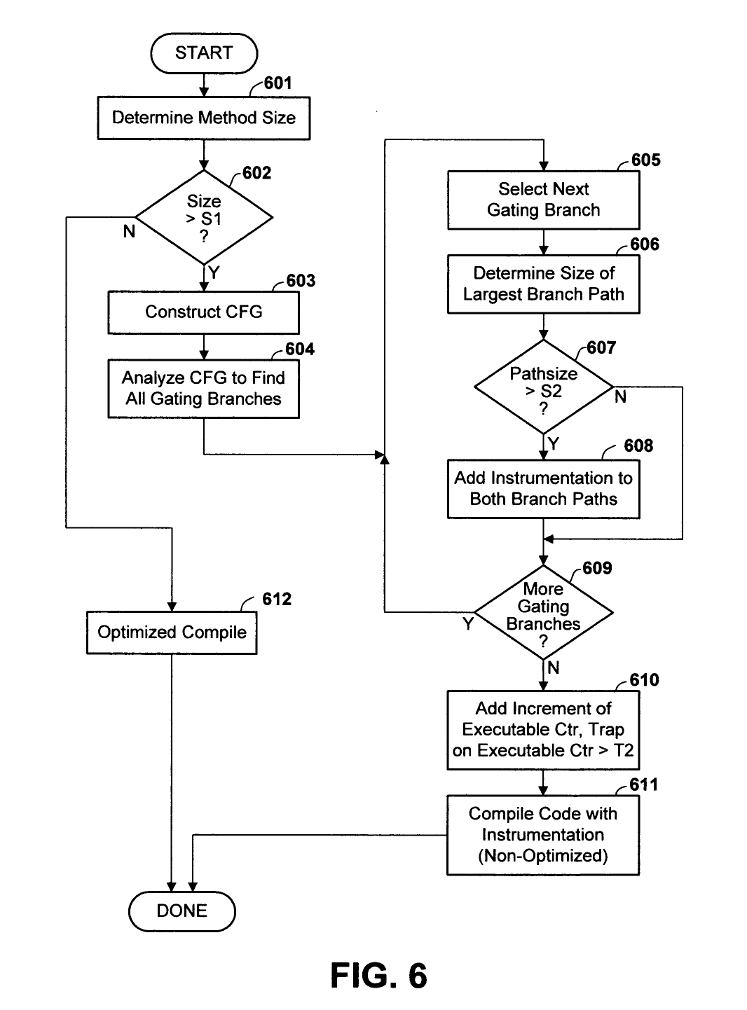

If the call resolves to a method which has not previously been compiled (the ‘N’ branch from step 505), then the JVM facility increments method counter 303 corresponding to the called method (step 507). If method counter 303 then exceeds a pre-determined threshold T1, the ‘Y’ branch is taken from step 508, causing the method to undergo a first stage compilation. The first stage compilation is represented in the high-level flowchart of FIG. 5 as block 509, and is shown in greater detail in FIG. 6. After the method has been compiled, the compiled executable code embodying the method is then executed (step 506), and following execution the next bytecode is retrieved for processing by the interpreter (step 502).

If the method counter does not exceed threshold T1 (the ‘N’ branch from step 508), the interpreter executes the method call in interpretive mode by retrieving and executing the appropriate routine for executing the method call bytecode (step 510). The next bytecode is then retrieved (step 502).

If the bytecode retrieved at step 502 was not a method call, the ‘N’ branch is taken from step 503. In this case, if the bytecode was anything other than a bytecode ending program execution (the ‘N’ branch from step 511), the interpreter retrieves and executes the routine which interprets the corresponding bytecode (step 510), returning to step 502 when the bytecode routine completes. If the retrieved bytecode was a bytecode ending program execution, the ‘Y’ branch is taken from step 511, and program execution ends (step 512).

FIG. 6 is a flow diagram showing in expanded form the first stage dynamic compilation process, represented in FIG. 5 by step 509. Referring to FIG. 6, the JIT compiler makes an initial determination of the method size (step 601). This determination should include any methods that will be inlined into the compiled code. Since the size determination is intended only as an approximation, any of various suitable size measurements may be used. In the preferred embodiment, the method size is the number of bytecodes in the method and any included methods to be inlined. However, other measures of size could alternatively be used. If the size determined at step 601 exceeds a pre-determined threshold S1 (the ‘Y’ branch from step 602), then the compiler constructs a control flow graph (CFG) of the method being compiled (step 603), and analyzes the CFG to find all gating branches (step 604).

The compiler selects a gating branch (step 605) and determines the code size of the largest of the branch paths from the gating branch to the point of convergence of the branches. The size is measured similarly to the measure at step 601, i.e., by taking a bytecode count of the bytecodes in the branch path, including any inlined bytecodes from called methods in the branch path. The number of bytecodes in a branch path is the total number of bytecodes in all paths within the branch path, and not the number of bytecodes in a single direct path to the point of convergence. For example, referring to FIG. 4, the number of bytecodes in the branch path along arc 422 from the gating branch at node 402 to the point of convergence at node 409 is the sum of the number of bytecodes in nodes 403, 404, 405 and 406, even though, during execution, only one of node 404 or 405 will be executed.

If the path size of the largest branch path exceeds a pre-determined threshold S2 (the ‘Y’ branch from step 607), then instrumentation is added to both branch paths from the gating branch (step 608). This counter data generated by this instrumentation will be used in the second stage compilation to determine whether the place the code in the cold cache.

If the pathsize does not exceed S2, step 608 is by-passed, i.e., instrumentation is not added to either branch path. The reason for this is that if both branch paths are relatively small, there will be little benefit in putting the branch code in the cold cache. In this case, it is deemed better to simply put both branches in the primary code cache. Hence there is no point in instrumenting the gating branch because, regardless of the actual counts at the gating branch, the code for both branch paths will be placed in the primary code cache during any second stage compilation.

If more gating branches remain to be processed (the ‘Y’ branch from step 609), the compiler returns to step 605 to select the next gating branch. When all gating branches have been processed, the ‘N’ branch is taken from step 609. The compiler adds instrumentation to the beginning of the compiled method to increment an executable counter, which counts the total number of times the method is called for execution, and to force a trap when the executable counter exceeds a pre-determined threshold T2 (step 610). This trap will trigger the second stage compilation, as described herein. The code with the instrumentation thus added is then compiled (step 611). Preferably, the compilation performed at step 611 is a simplified, non-optimized compilation, because it is expected that, should the method be executed frequently, it will eventually be re-compiled in optimized form in the second stage of compilation.

If, at step 602, the total size of the method and any included inlined code did not exceed S1, the ‘N’ branch is taken from step 602, and the code is compiled without instrumentation (step 612), the compiled code being placed in the primary code cache. In the preferred embodiment, this compilation is an optimized compilation. Because the amount of code is relatively small, the benefit from segregating infrequently executed code blocks to the cold code cache is minor at best. Therefore, no attempt will be made to compile a second time after collecting instrumentation data, and the code is directly optimized in the first compilation stage. It would alternatively be possible to add the instrumentation added at step 610, and perform a non-optimized compile (as in step 611), allowing the method to be compiled a second time in optimized form if the necessary threshold T2 is reached during execution.

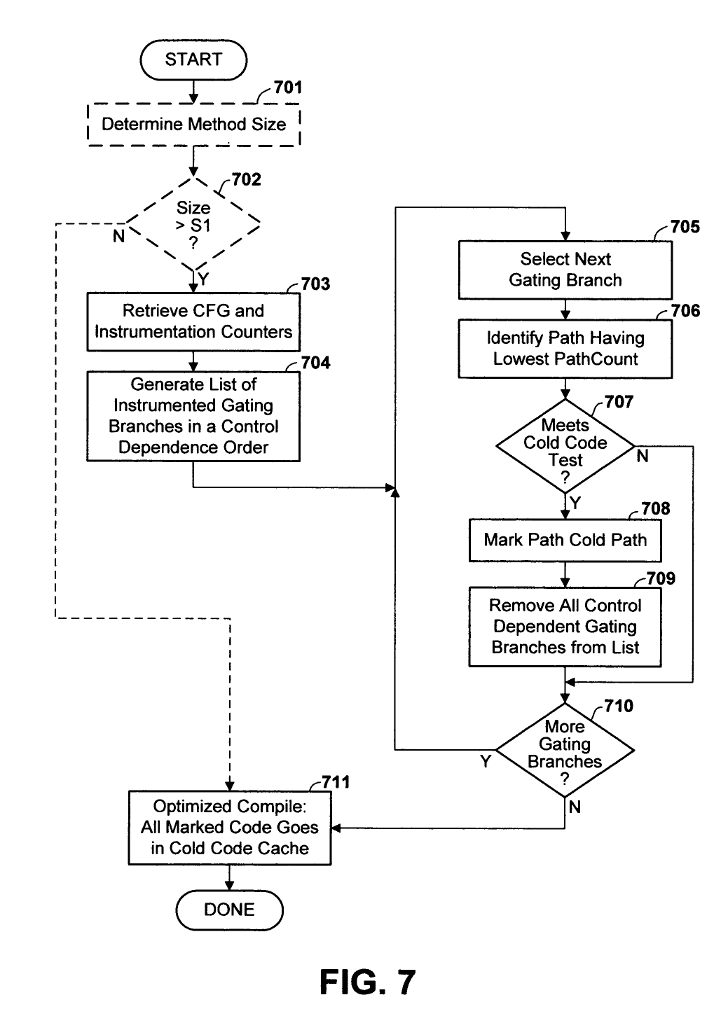

Referring again to FIG. 5, during execution a method which has been compiled using the process described above with respect to FIG. 6 will be called from time to time, as represented by step 506. Each time the method is called, its executable counter (added at step 610) is incremented. If the executable counter exceeds threshold T2, the trap is triggered, as indicated by the dashed lines to step 513. In this case, a second stage compilation is performed. FIG. 7 is a flow diagram showing in expanded form this second stage compilation process.

Referring to FIG. 7, the JIT compiler makes an initial determination of the method size (step 701), including any code that will be inlined into the compiled method, as in the first stage compilation. If the size determined at step 701 exceeds a pre-determined threshold S1 (the ‘Y’ branch from step 702), then the compiler proceeds to determine which, if any, of the branch paths from gating branches should be placed in the cold code cache, beginning at step 703. It will be noted that if an optimized compile is performed at step 612, as in the preferred embodiment, then the second stage compilation is only initiated when steps 603-611 were performed in the first stage compilation. In this case, steps 701-702 may be omitted, and the second stage compilation begins with step 703. For this reason, steps 701-702 are shown in dashed lines. Steps 701-702 should be performed if the compilation in step 612 was non-optimized.

The compiler retrieves the control flow graph 306 and instrumentation counters 307 from the method data set (step 703). Using the data retrieved at step 703, the compiler generates a list of instrumented gating branches in a control dependence order (step 704). A control dependence ordering is an ordering in which any gating branch which is control dependent on another gating branch follows the branch on which it is control dependent. There are potentially a large number of possible list orderings in control dependence order, and any such ordering will be sufficient.

Having generated the list in control dependence order, the compiler selects the next gating branch on the list (step 705). The branch counters for the paths exiting the gating branch are compared, and the counter with path with the lowest path count is selected for possible inclusion in the cold cache (step 706).

The compiler then tests for inclusion of the selected path in the cold cache (step 707). In the preferred embodiment, the test is performed by evaluating the logical expression:

$$( BranchCount > BT ) AND ( \frac{PathCount}{BranchCount} < PT ) AND ( PathSize > S2 ) , \qquad ( 1 )$$

where PathCount is the count of the number oftimes the selected branch path has been taken, BranchCount is the sum of the PathCounts of the branch paths from the selected gating branch, PathSize is the size (in bytecodes) of the code within the branch path, up to the point of convergence with the other path from the gating branch, and BT, PT and S2 are pre-defined thresholds. The first part of the test is used to assure that the gating branch has been encountered a statistically significant number of times during execution. The second part requires that the proportion of branches to the selected branch path be sufficiently low. The third part requires the size of the selected branch path to meet some threshold, i.e., if the branch path is too small, it is better to simply include it in the primary code cache even though it is not taken very often.

If the test conditions of expression (1) above are met, the ‘Y’ branch is taken from step 707, and the branch path is marked for inclusion in the cold code cache (step 708). The compiler then examines the list of gating branches, and removes all gating branches which are control dependent on the selected branch from the list (step 709). It is unnecessary to test these branches for inclusion in the cold code cache, since the test performed at step 707 has determined that the entire selected branch path, including all gating branches and branch paths within it, will be placed in the cold code cache.

If the test conditions of expression (1) above are not met, the ‘N’ branch from step 707 is taken, causing steps 708 and 709 to be by-passed. I.e., the code is not marked, and at least some of it will be in the primary code cache, although it is possible that a branch path from a control dependent gating branch within it will be subsequently marked for inclusion in the cold cache.

The compiler then determines whether more gating branches are on the list (step 710), and if so returns to step 705 to select the next gating branch for analysis. When all gating branches have thus been analyzed, the ‘N’ branch is taken from step 710. The compiler then performs an optimized compilation in which all unmarked code blocks are placed in the primary code cache, and all marked code is placed in the cold code cache (step 711). The second stage compilation is then complete.

If, at step 702, the size of the method to be compiled does not meet threshold S1, steps 703-710 are by-passed, and the compiler proceeds directly to step 711. In this case, since no code blocks were marked for inclusion in the cold code cache, all compiled code is placed in the primary code cache.

After completion of the second stage compilation, the JVM facility executes the called method by executing the just compiled code. In the flowchart of FIG. 5, this is indicated by the dashed line returning to step 506 from step 513. After execution of the compiled code, the interpreter then returns to step 502 and selects the next bytecode for processing.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, recordable type media such as volatile and non-volatile memory devices, floppy disks, hard-disk drives, CD-ROM's, DVD's, magnetic tape, and transmission-type media such as digital and analog communications links, including wireless communications links. An example of signal-bearing media is illustrated in FIG. 1 as system memory 102, and as data storage devices 125-127.

In accordance with the preferred embodiment, data needed for determining which code paths are more frequently executed (program profile data) is obtained by instrumenting the “gating branches”, as defined above. The use of gating branch instrumentation provides a relatively simple, yet reasonably accurate, means for determining the frequently vs. infrequently executed code. However, it will be understood that many variations in the implementation of a data gathering functions for determining frequently executed code are possible within the scope of the present invention, and that the present invention is not necessarily limited to the “gating branch” concept. For example, a more thorough code analysis might instrument loops and other code paths which do not necessarily conform to the “gating branch” definition herein. Other techniques hereafter developed might be used, alone or in conjunction with the instrumentation of code paths, to predict the more frequently executed paths.

In the preferred embodiment, program profile data is obtained by compiling in a two-stage process, in which the first stage inserts instrumentation for counting the frequency of execution of certain branch paths. It would alternatively be possible to obtain program profile data while running in interpretive mode. Although such an alternative would require only a single compilation, it would have its own performance drawbacks. For example, such an alternative would appear to require either that each and every branch be instrumented, or that some form of pre-interpretive analysis be performed on the code to determine which branch paths should be instrumented (e.g., that a control flow graph be constructed). As a result of these and other considerations, the two-stage compilation of the preferred embodiment appears to be generally superior. There may be some environments, or improvements to the analytical techniques, which would make collecting profile data in interpretive mode preferable.

Although the preferred embodiment has been described above with respect to the JAVA programming language and certain object-oriented constructs, the present invention is not limited to JAVA or object-oriented languages. The word “method” is used herein consistent with JAVA terminology, but the techniques described herein are applicable to any procedure, method or similar programming entity, by whatever name.

Although a specific embodiment of the invention has been disclosed along with certain alternatives, it will be recognized by those skilled in the art that additional variations in form and detail may be made within the scope of the following claims:

What is claimed is:

1. A method for executing a program in a dynamically compiled environment, comprising the steps of:
dynamically measuring execution frequency of a plurality of portions of said program during program execution;
dynamically compiling at least part of said program, said compiling step placing compiled code embodying a first subset of said plurality of portions in a first memory location, and placing compiled code embodying a second subset of said plurality of portions in a second memory location different from said first memory location, wherein compiled code is allocated to said first and second memory locations using said dynamically measured execution frequency; and
executing code compiled by said dynamically compiling step.

2. The method for executing a program in a dynamically compiled environment of claim 1, further comprising the steps of:
dynamically measuring, for each of a plurality of procedures, a respective number of times the procedure is called; and
triggering compilation of a procedure when the respective number of times the procedure is called exceeds a pre-determined threshold.

3. The method for executing a program in a dynamically compiled environment of claim 1, wherein said step of dynamically measuring execution frequency of a plurality of portions of said program comprises dynamically measuring respective frequencies of execution of branch paths of a plurality of gating branches.

4. The method for executing a program in a dynamically compiled environment of claim 1, further comprising the step of:
dynamically performing a first stage compilation of at least part of said program, said first stage compilation inserting instrumentation code for dynamically measuring execution frequency of a plurality of portions of said program compiled by said first stage compilation;
wherein said step of dynamically measuring execution frequency of a plurality of portions of said program during program execution is performed using said instrumentation code inserted by said first stage compilation;
wherein said step of dynamically compiling at least part of said program comprises re-compiling at least a part of said program compiled by said step of dynamically performing a first stage compilation after performing said step of dynamically performing a first stage compilation.

5. The method for executing a program in a dynamically compiled environment of claim 4, wherein said step of dynamically compiling at least part of said program re-compiles at least part of said program compiled by said step of dynamically performing a first stage compilation utilizing a higher degree of optimization than used in said step of dynamically performing a first stage compilation.

6. The method for executing a program in a dynamically compiled environment of claim 4, wherein said first stage compilation inserts instrumentation code measuring frequency of execution of branch paths of a plurality of gating branches.

7. The method for executing a program in a dynamically compiled environment of claim 4,
wherein said first stage compilation inserts instrumentation code measuring a respective number of times each procedure compiled by said step of dynamically performing a first stage compilation is called; and
wherein said step of re-compiling at least part of said program is triggered with respect to each procedure when the respective number of times the procedure has been called exceeds a pre-determined threshold.

8. The method for executing a program in a dynamically compiled environment of claim 4, further comprising the steps of:
with respect to each respective procedure of a plurality of procedures of said program, determining whether the respective procedure exceeds a pre-determined size threshold;
if the respective procedure exceeds said pre-determined size threshold, then dynamically performing said first stage compilation of the respective procedure, said first stage compilation inserting said instrumentation code; and
if the respective procedure does not exceed said pre-determined size threshold, then dynamically performing a compilation of the respective procedure without inserting said instrumentation code.

9. The method for executing a program in a dynamically compiled environment of claim 1, wherein said dynamically compiled environment is a JAVA Virtual Machine environment and said step of dynamically compiling at least part of said program is performed by a JAVA JIT compiler.

10. A computer program product supporting execution of a program in a dynamically compiled environment, comprising:
a plurality of computer executable instructions recorded on signal-bearing media, wherein said instructions, when executed by at least one computer system, cause the at least one computer system to perform the steps of:
dynamically measuring execution frequency of a plurality of portions of said program during program execution;
dynamically compiling at least part of said program, said compiling step placing compiled code embodying a first subset of said plurality of portions in a first memory location, and placing compiled code embodying a second subset of said plurality of portions in a second memory location different from said first memory location, wherein compiled code is allocated to said first and second memory locations using said dynamically measured execution frequency; and
executing code compiled by said dynamically compiling step.

11. The computer program product of claim 10, wherein said instructions further cause the at least one computer to perform the steps of:
dynamically measuring, for each of a plurality of procedures, a respective number of times the procedure is called; and
triggering compilation of a procedure when the respective number of times the procedure is called exceeds a pre-determined threshold.

12. The computer program product of claim 10, wherein said step of dynamically measuring execution frequency of a plurality of portions of said program comprises dynamically measuring respective frequencies of execution of branch paths of a plurality of gating branches.

13. The computer program product of claim 10, wherein said instructions further cause the at least one computer to perform the step of:
dynamically performing a first stage compilation of at least part of said program, said first stage compilation inserting instrumentation code for dynamically measuring execution frequency of a plurality of portions of said program compiled by said first stage compilation;
wherein said step of dynamically measuring execution frequency of a plurality of portions of said program during program execution is performed using said instrumentation code inserted by said first stage compilation;
wherein said step of dynamically compiling at least part of said program comprises re-compiling at least apart of said program compiled by said step of dynamically performing a first stage compilation after performing said step of dynamically performing a first stage compilation.

14. The computer program product of claim 13, wherein said step of dynamically compiling at least part of said program re-compiles at least part of said program compiled by said step of dynamically performing a first stage compilation utilizing a higher degree of optimization than used in said step of dynamically performing a first stage compilation.

15. The computer program product of claim 13, wherein said first stage compilation inserts instrumentation code measuring frequency of execution of branch paths of a plurality of gating branches.

16. The computer program product of claim 13,
wherein said first stage compilation inserts instrumentation code measuring a respective number of times each procedure compiled by said step of dynamically performing a first stage compilation is called; and
wherein said step of re-compiling at least part of said program is triggered with respect to each procedure when the respective number oftimes the procedure has been called exceeds a pre-determined threshold.

17. The computer program product of claim 13, wherein said instructions further cause the at least one computer to perform the steps of:
with respect to each respective procedure of a plurality of procedures of said program, determining whether the respective procedure exceeds a pre-determined size threshold;
if the respective procedure exceeds said pre-determined size threshold, then dynamically performing said first stage compilation of the respective procedure, said first stage compilation inserting said instrumentation code; and
if the respective procedure does not exceed said pre-determined size threshold, then dynamically performing a compilation of the respective procedure without inserting said instrumentation code.

18. The computer program product of claim 10, wherein said dynamically compiled environment is a JAVA Virtual Machine environment and said step of dynamically compiling at least part of said program is performed by a JAVA JIT compiler.

19. A computer system, comprising:
at least one processor;
a memory;
a dynamic compilation execution facility embodied as a plurality of instructions storable in said memory for execution by said at least one processor, said dynamic compilation execution facility dynamically compiling computer programs invoked for execution on said at least one processor;
wherein said dynamic compilation execution facility dynamically compiles a first subset of portions of a program invoked for execution to a primary code cache at a first location in said memory, and dynamically compiles a second subset of portions of said program invoked for execution to a cold code cache at a second location in said memory, said first and second subsets being discrete, said first and second locations being different, said dynamic compilation execution facility automatically determining whether each respective portion of said program is to be compiled to said primary code cache and whether each respective portion is to be compiled to said cold code cache using a respective determination of execution frequency associated with the respective portion.

20. The computer system of claim 19, wherein said dynamic compilation execution facility dynamically compiles each respective procedure of a plurality of procedures of said program responsive to determining that a respective number of times the procedure has been called exceeds a pre-determined threshold.

21. The computer system of claim 19, wherein said dynamic compilation execution facility determines respective execution frequencies associated with portions of said program by inserting instrumentation code into said program and collecting data generated by said instrumentation code.

22. The computer system of claim 19, wherein said dynamic compilation execution determines execution frequencies associated with respective branch paths of a plurality of gating branches.

23. The computer system of claim 19, wherein said computer system further comprises a static front-end compiler for compiling source code to an intermediate form, said dynamic compilation execution facility dynamically compiling computer programs from said intermediate form.

24. A method for executing a program in a dynamically compiled environment, comprising the steps of:
generating instrumentation code for at least part of said program during program execution, said instrumentation code measuring a respective execution frequency associated with each of a plurality of portions of said program;
obtaining execution frequency data from said instrumentation code during program execution;
dynamically compiling at least part of said program, said compiling step placing compiled code embodying a first subset of said plurality of portions in a primary code cache at a first memory location, and placing compiled code embodying a second subset of said plurality of portions in a cold code cache at a second memory location different from said first memory location, said first and second subsets being discrete, wherein compiled code is allocated to said primary code cache and said cold code cache using said execution frequency data; and
executing code compiled by said dynamically compiling step.

25. The method for executing a program in a dynamically compiled environment of claim 31, further comprising the step of:
wherein said step of generating instrumentation code is performed as part of a first stage compilation of at least part of said program;
wherein said step of dynamically compiling at least part of said program comprises re-compiling at least a part of said program compiled by said first stage compilation after performing said first stage compilation.

26. The method for executing a program in a dynamically compiled environment of claim 31, wherein said instrumentation code dynamically measures respective frequencies of execution of branch paths of a plurality of gating branches of said program.
